(19) United States
(12) Patent Application Publication
(10) Pub. No.: US 2011/0049041 A1
(43) Pub. Date: Mar. 3, 2011

(54) FUEL FILTER ELEMENT

(75) Inventor: Toshiyuki Yonemoto, Nagoya-city (JP)

(73) Assignee: DENSO CORPORATION, Kariya-city (JP)

(21) Appl. No.: 12/843,243

(22) Filed: Jul. 26, 2010

(30) Foreign Application Priority Data
Aug. 26, 2009 (JP) 2009-195828

(51) Int. Cl. B01D 29/46

(52) U.S. Cl. 210/490

(57) ABSTRACT

A fuel filter element includes a first layer and a second layer. The first layer has a first pore size. The second layer is stacked on the first layer and has a second pore size smaller than the first pore size. The second layer is a filter paper made of a fiber including a refined fiber and an unrefined organic fiber. The refined fiber is a cellulose fiber treated with a refining process and fibrillated so as to have a freeness within a range from 120 ml to 180 ml. The unrefined organic fiber has a fiber diameter within a range from 8 μm to 13 μm and is not treated with a refining process. The refined fiber accounts from 70 weight % to 85 weight % of the fiber and the unrefined organic fiber accounts for the remain.

### CROSS REFERENCE TO RELATED APPLICATIONS

The present application is based on and claims priority to Japanese Patent Application No. 2009-195828 filed on Aug. 26, 2009, the contents of which are incorporated in their entirety herein by reference.

### BACKGROUND OF THE INVENTION

1. Field of the Invention

The present invention relates to a fuel filter element including two layers having different pore sizes.

2. Description of the Related Art

U.S. Pat. No. 7,137,510 (corresponding to JP-T-2001-523562) discloses a filter element having two layers joined contiguously in the direction of flow.

A pore size of the layer arranged on an upstream side is larger than a pore size of the layer arranged on a downstream side so that a filter accuracy increases in the direction of flow. That is, the layer arranged on the upstream side is a coarse layer and the layer arranged on the downstream side is a fine layer that is finer than the coarse layer. In the direction of flow, firstly, large foreign materials are captured with the coarse layer. Then, small foreign materials passing through the coarse layer are captured with the fine layer. Thereby, a filter life can be improved while securing predetermined filter efficiency.

The fine layer is a filter paper. The filter paper includes a cellulose fiber and may include a synthetic fiber such as a polyester fiber and a glass fiber of up to 50%.

The pore site of the fine layer which is made of the cellulose fiber such as a wood pulp and the synthetic fiber is large. Thus, when the filter element is used for a filter element of a fuel filter that is disposed on a passage for supplying fuel from a fuel tank to an engine, the filter element is difficult to effectively capture a foreign material such as a grain of sand less than 10 μm, and a filter efficiency may be not sufficient. Therefore, in the filter element having two layers, a configuration of the fine layer is especially important.

JP-A-2000-153116 discloses a filter element that includes a filter paper containing from 10 weight % to 40 weight % refined fiber and from 90 weight % to 60 weight % unrefined fiber. The refined fiber is formed by refining and fibrillating a natural fiber so as to have a freeness of less than or equal to 500 ml. The unrefined fiber is, for example, a cellulose fiber that is not fibrillated. The unrefined fiber is not limited to a cellulose fiber such as a wood pulp. The refined fiber may also be an organic fiber such as rayon and polyester.

The filter element includes the refined fiber that is fibrillated. However, a large part of the whole fiber is the unrefined fiber that is not fibrillated. Thus, the pore size of the filter element is large, and the filter element is difficult to effectively capture foreign materials such as a grain of sand less than 10 μm. The filter efficiency may be increased by increasing a combination ratio of the refined fiber over 60%. However, simply increasing the combination ratio may increase a pressure loss due to the filter paper and a passing resistance of fluid may be excessively large.

### SUMMARY OF THE INVENTION

In view of the foregoing problems, it is an object of the present invention to provide a fuel filter element having a high filter efficiency and a long filter life.

A fuel filter element according to an aspect of the present invention includes a first layer and a second layer. The first layer has a first pore size. The second layer is stacked on the first layer and has a second pore size smaller than the first pore size. The second layer is a filter paper made of a fiber including a refined fiber and an unrefined organic fiber. The refined fiber is a cellulose fiber treated with a refining process and fibrillated so as to have a freeness within a range from 120 ml to 180 ml. The unrefined organic fiber has a fiber diameter within a range from 8 μm to 13 μm. The unrefined organic fiber is not treated with a refining process. The refined fiber accounts for a predetermined ratio of the fiber and the unrefined organic fiber accounts for the remain. The predetermined ratio is within a range from 70 weight % to 85 weight %.

The fuel filter element can have a high filter efficiency and a long filter life.

### BRIEF DESCRIPTION OF THE DRAWINGS

Additional objects and advantages of the present invention will be more readily apparent from the following detailed description of exemplary embodiments when taken together with the accompanying drawings. In the drawings:

FIG. 1 is a diagram showing a filter element according to an exemplary embodiment of the present invention;

FIG. 2 is a graph showing a relationship between a freeness and a filter efficiency;

FIG. 3 is a graph showing a relationship between a combination ratio of a refined fiber and a filter efficiency;

FIG. 4 is a graph showing a relationship between a combination ratio of a refined fiber and a pressure loss;

FIG. 5 is a graph showing a relationship between a fiber diameter of a polyester fiber and a filter efficiency;

FIG. 6 is a graph showing a relationship between a fiber diameter of a polyester fiber and a pressure loss:

FIG. 7 is a cross-sectional view of a fine layer according to a first comparative example;

FIG. 8 is a cross-sectional view of a fine layer according to a second comparative example; and

FIG. 9 is a cross-sectional view of a fine layer according to an exemplary embodiment of the present invention.

### DETAILED DESCRIPTION OF THE EXEMPLARY EMBODIMENTS

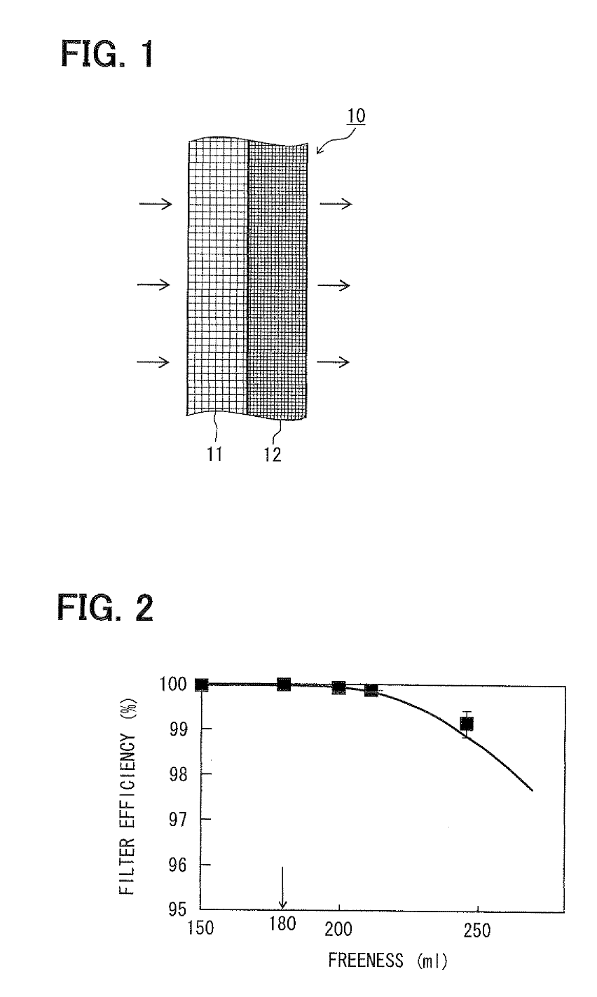

A filter element 10 according to an exemplary embodiment of the present invention will be described with reference to FIG. 1. The filter element 10 is used for a filter element of a fuel filter that is disposed on a passage for supplying fuel from a fuel tank to an engine with a fuel pump. The filter element 10 is housed in a housing (not shown) made of, for example, resin and configurates the fuel filter with the housing. The filter element 10 is made of a material having a high oil resistance. In the present embodiment, the fuel is light oil, the engine is a diesel engine, and the filter element 10 is a filter element for a diesel.

The filter element 10 has a two-layer structure including a coarse layer 11 and a fine layer 12. The coarse layer 11 can function as a first layer and the fine layer 12 can function as a second layer. The coarse layer 11 is disposed on an upstream side in a flow direction of the fuel. The coarse layer 11 has a first pore size. The fine layer 12 is stacked on the coarse layer 11 and is disposed on a downstream side in the flow direction. The fine layer 12 has a second pore size smaller than the first pore size. In other words, the fine layer 12 is finer than the coarse layer 11. In the flow direction, firstly, large foreign materials such as a grain of sand having a particle size of greater than or equal to 10 μm are captured with the coarse layer 11. Then, small foreign materials passing through the coarse layer 11 such as a grain of sand having a particle size of less than 10 μm are captured with the fine layer 12. Thus, compared with a filter element having a single layer structure, the filter element 10 can have a long filter life while securing a filter efficiently and can increase a storage capacity.

The coarse layer 11 is coarser than the fine layer 12. The coarse layer 11 may be made of, for example, a natural fiber such as a pulp, a chemical fiber such as polyester, or a combination of a natural fiber and a chemical fiber. The coarse layer 11 may be either a nonwoven fabric or a filter paper. When the coarse layer 11 is made of an organic fiber and does not include a metal component such as a glass fiber and a metal fiber, the coarse layer 11 can restrict a problem that a metal component (for example, Na in glass) is eluted to the fuel, a metal salt is generated, the melt salt attaches to a sliding portion of an injector, and malfunction occurs.

For example, the coarse layer 11 is a filter paper made of a combination of a wood pulp fiber and a polyester fiber. In the filter paper, the wood pulp fiber accounts for about 25 weight % and the polyester fiber accounts for the remain, that is, about 75 weight %. The wood pulp fiber is rectangular in cross section, and one side is 10 μm and the other side is 50 μm. The polyester fiber is circular in cross section, and a diameter is within a range from 3 μm to 5 μm. The filter paper is impregnated with resin such as phenol resin, and thereby the filter paper is reinforced and is integrated with the fine layer 12. When the coarse layer 11 is a nonwoven fabric, the coarse layer 11 may be integrated with the fine layer 12 by a known method such as an embossing process and a laminating process.

The fine layer 12 is finer than the coarse layer 11. The filter layer 12 is a filter paper made of a fiber including a refined fiber and an unrefined organic fiber. The refined fiber is a cellulose fiber treated with a refining process and fibrillated so as to have a freeness within a range from 120 ml to 180 ml. The unrefined organic fiber is not treated with a refining process and has a fiber diameter within a range from 8 μm to 13 μm. The refined fiber accounts for a predetermined ratio of the fiber and the unrefined organic fiber accounts for the remain. The predetermined ratio is within a range from 70 weight % to 85 weight %. Thus, the unrefined organic fiber is within a range from 30 weight % to 15 weight %. The fine layer 12 includes only organic fibers as fiber material and does not include a metal component such as a metal fiber and a glass fiber. Thus, a problem due to a metal salt does not occur.

The cellulose fiber may be either a natural fiber such as a pulp fiber or a chemical fiber (regenerated fiber) such as a rayon fiber. The cellulose fiber is a bundle of fibrils. In the refining process, the cellulose fiber is applied with force so as to be rubbed, and a part of the fibrils appears at a surface of the cellulose fiber. Thus, the cellulose fiber has a body portion that remains a bundle without being fuzzy and a fuzzy portion on a surface of the body portion. The fuzzy portion uniformly disperses and is tangled with a frame fiber configurated by the body portion of the cellulose fiber and the unrefined organic fiber. Thus, the fine layer 12 has fine pores and predetermined clearances which are three-dimensionally arranged.

The freeness is measured with a Canadian standard freeness tester based on a freeness test method specified in Japanese Industrial Standards code: JIS P8121. The unrefined organic fiber is an organic fiber which is not treated with a refining process. The unrefined organic fiber may be either a natural fiber or a chemical fiber. When the unrefined organic fiber is a chemical fiber (for example, a polyester fiber) which has greater physical characteristics such as tensile strength than the cellulose fiber used as the refined fiber, the fine layer 12 can have a high durability.

For example, the fine layer 12 is a filter paper made of a combination of the refined fiber and a polyester fiber. The polyester fiber is made of, for example, polyethylene terephthalate (PET). In the filter paper, the refined fiber accounts for 80 weight % and the polyester fiber accounts for the remain, that is, about 20 weight %. The refined fiber is formed from a rayon fiber that is circular in cross section and has a fiber diameter of 13 μm. The refined fiber is formed by refining and fibrillating the rayon fiber so as to have a freeness of 150 ml. The polyester fiber is circular in cross section and has a fiber diameter of 13 μm. A passing particle size of the filter paper is less than 5 μm. The filter paper is impregnated with resin such as phenol resin, and thereby the fine layer 12 is reinforced and is integrated with the coarse layer 11.

As described above, both of the coarse layer 11 and the fine layer 12 may be the filter papers, and the coarse layer 11 and the fine layer 12 may be integrated by the impregnated resin. Thus, the coarse layer 11 and the fine layer 12 can be formed by a paper making process. For example, the fine layer 12 can be made with a paper machine firstly, and then the coarse layer 11 can be made on the fine layer 12 with a paper machine. Thus, a manufacturing process can be simple and a manufacturing cost can be reduced, In addition, because both of the coarse layer 11 and the fine layer 12 are the filter papers, the coarse layer 11 and the fine layer 12 can be easily bent into a predetermined shape (for example, a chrysanthemum shape).

The fine layer 12 can be evaluated as follows. A filter efficiency is measured by a method specified in ISO 19438. In a measurement of the filter efficiently, a filter area is 45 cm², a flow rate is 0.5 L/min, a test dust is ISO12103-A3, a dust concentration on an upstream side is 10 mg/L. In a measurement of a pressure loss, a filter area is 530 cm², a flow rate is 0.6 L/min, test oil is JIS No. 2 light oil specified in Japanese Industrial Standards cord: JIS K2204, and a temperature is 38° C. The refined fiber is formed by refining and fibrillating a rayon fiber that is circular in cross section and has a fiber diameter of about 13 μm. The unrefined organic fiber is a polyester fiber that is circular in cross section. A thickness of the fine layer 12 in the flow direction is 0.25 mm.

Filter efficiencies of filter papers each including only the refined fiber as fiber are measured with the above-described manner. A relationship between the freeness and the filter efficiency (so-called 5 μm efficiency) of the filter papers is shown in FIG. 2. When the freeness is 150 ml or 180 ml, the filter efficiency is 100%. However, when the freeness is larger than 180 ml (200 ml, 210 ml, 240 ml in FIG. 2), the filter efficiency becomes lower as the freeness becomes larger. This may be because when the freeness is greater than 180 ml, a degree of refining is not enough to be used as a fuel filter element, that is, a fuzzy portion of the fibrils that functions to reduce the pore size is few.

When the freeness is small, a ratio of the fuzzy portion increases and a diameter of the body portion of the cellulose fiber that remains the bundle without being fuzzy is reduced. In other words, the frame fiber becomes thinner. According to a study by the inventor, when the freeness is lower than 120 ml, it becomes difficult to make a filter paper. Thus, the degree of refining is set so that the freeness is within a range from 120 ml to 180 ml. When the refined fiber is fibrillated so as to have a freeness within a range from 120 ml to 180 ml, the filter paper can be used as the fine layer 12 and the filter efficiency can be improved.

According to the study by the inventor, in the refined fibers fibrillated so as to have a freeness within a range from 120 ml to 180 ml, the diameter of the body portion of the cellulose fiber is within a range from 10 μm to 11 μm. Thus, the refined fiber fibrillated so as to have a freeness within a range from 120 ml to 180 ml can be formed by refining and fibrillating the rayon fiber that is circular in cross section and has a fiber diameter of 13 μm so that the diameter of the body portion becomes from 10 μm to 11 μm. A diameter of a general wood pulp is within a range from 10 μm to 50 μm. Thus, it can be said that the diameter from 10 μm to 11 μm is within a range of the diameter of a wood pulp. By setting the diameter of the body portion to be from 10 μm to 11 μm, the body portion can function as the frame fiber, and a combination ratio of the refined fiber can be increased as described below.

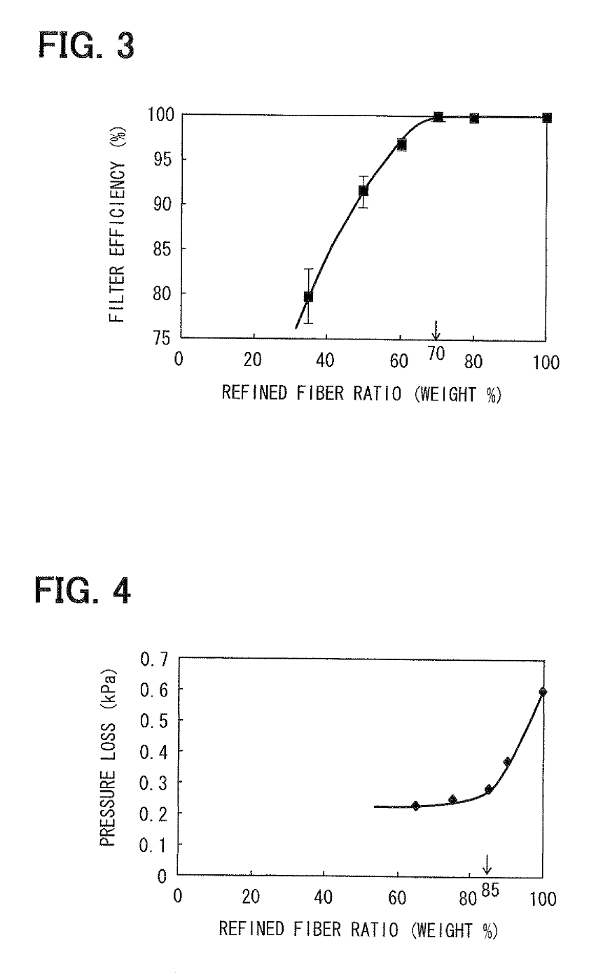

Filter efficiencies of filter papers having various combination ratios of the refined fiber and the polyester fiber are measured with the above-described conditions. A relationship between the combination ratio of the refined fiber and the filter efficiency (so-called 5 μm efficiency) is show in FIG. 3. The polyester fiber has a fiber diameter of 13 μm. The freeness is set to 180 ml, which is the upper limit. When the combination ratio of the refined fiber is greater than or equal to 70 weight % (in FIG. 3, 70 weight %, 80 weight %, and 100 weight %), the filter efficiency is 100%. When the combination ratio of the refined fiber is less than 70 weight % (in FIG. 3, 60 weight %, 50 weight %, and 35 weight %), the filter efficiency becomes lower as the combination ratio becomes smaller. This may be because when the combination ratio is less than 70 weight %, the fuzzy portion that functions to reduce the pore size is too few to be used as a fuel filter element.

The relationship between the combination ratio of the refined fiber and the filter efficiency is also studied for each case where the freeness is 120 ml or 150 ml. According to the study, the combination ratio of the refined fiber required for achieving the filter efficiency of 100% becomes smaller as the freeness becomes smaller. That is, in each case where the freeness is 120 ml or 150 ml, the filter efficiency is 100% when the combination ratio of the refined fiber is greater than or equal to 70 weight %. Therefore, the combination ratio of the refined fibers is set to be greater than or equal to 70 weight %. Thereby, when the freeness is within a range from 120 ml to 180 ml, the filter efficiency can be 100%.

A relationship between the combination ratio of the refined fiber and a pressure loss in a case where the freeness is 180 ml is shown in FIG. 4. In the measurement of the pressure loss, the polyester fiber having a fiber diameter of 13 μm is used as the unrefined organic fiber in a manner similar to the measurement of the filter efficiency. As shown in FIG. 4, when the combination ratio of the refined fiber is less than or equal to 85 weight % (in FIG. 4, 85 weight %, 75 weight %, and 65 weight %), the pressure loss is stable around 0.25 kPa. When the combination ratio is greater than 85 weight % (in FIG. 4, 90 weight % and 100 weight %), the pressure loss drastically increases as the combination ratio increases compared with when the combination ratio is less than or equal to 85 weight %. This may be because when the combination ratio is greater than 85 weight %, the fuzzy portion that functions to reduce the pore size increases, and the clearances in the filter papers are reduced.

The relationship between the combination ratio of the refined fiber and the pressure loss is also studied for each case where the freeness is 120 ml or 150 ml. According to the study, the pressure loss increases as the freeness becomes smaller. Furthermore, in each of the cases, when the combination ratio is greater than 85 weight %, the pressure loss drastically increases as the combination ratio increases compared with when the combination ratio is less than or equal to 85 weight %. Therefore, the combination ratio of the refined fiber is set to be less than or equal to 85 weight %. Thereby, when the freeness is within a range from 120 ml to 180 ml, the pressure loss can be restricted and can be stabilized at a low value, and the filter life can be improved.

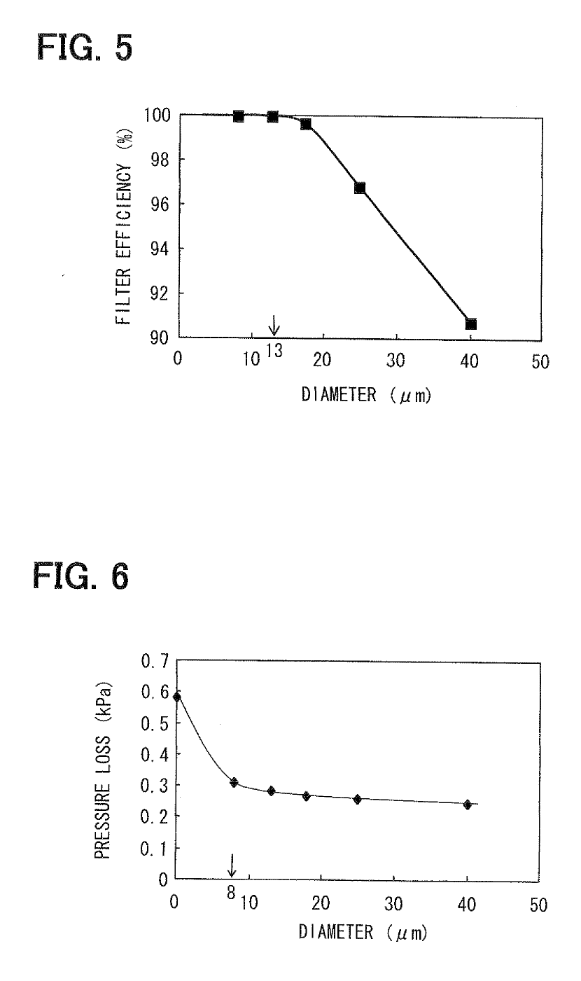

FIG. 5 shows a relationship between the fiber diameter of the polyester fiber that is combined with the refined fiber and the filter efficiency (so-called 5 μm efficiency) in a case where the freeness of the refined fiber is 180 ml and the combination ratio of the refined fiber to the polyester fibers is 70:30 (the lower limit of the combination ratio of the refined fiber). As shown in FIG. 5, when the fiber diameter of the polyester fiber is 8 μm or 13 μm, the filter efficiency is 100%. When the fiber diameter is 18 μm, the filter efficiency slightly falls below 100% and is about 99.5%. When the fiber diameter is 25 μm, the filter efficiency is about 96.5%. When the fiber diameter is 40 μm, the filter efficiency is about 90.5%. That is, the filter efficiency drastically reduces when the fiber efficiency is greater than 18 μm. This may be because when the fiber diameter of the polyester fiber is larger than 13 μm, especially larger than 18 μm, the polyester fiber that functions as the frame fiber is thick, and the fuzzy portion of the cellulose fiber is too few to uniformly disperse and to be tangled with the polyester fiber.

The relationship between the fiber diameter of the polyester fiber and the filter efficiency is also studied in other combination ratios (for example, the combination ratio of the refined fiber to the polyester fiber is 85:15). According to the study, the upper limit of the fiber diameter for achieving the filter efficiency of 100% becomes larger as the combination ratio of the refined fiber increases. Thus, also when the combination ratio of the refined fiber to the polyester fiber is 85:15, the filter efficiency is 100% when the fiber diameter is 13 μm. Therefore, the fiber diameter of the polyester fiber is set to be less than or equal to 13 μm. Thereby, when the combination ratio of the refined fiber is within a range from 70 weight % to 85 weight %, the filter efficiency can be 100%.

FIG. 6 shows a relationship between the fiber diameter of the polyester fiber and the pressure loss in a case where the freeness is 180 ml, and the combination ratio of the refined fiber to the polyester fiber is 85:15. Data of the fiber diameter of 0 μm is data of a sample in which the refined fiber accounts for 100 weight %. As shown in FIG. 6, when the fiber diameter is greater than or equal to 8 μm (in FIG. 6, 8 μm, 13 μm, 18 μm, 25 μm, and 40 μm), the pressure loss is stable around 0.25 kPa. When the fiber diameter is less than 8 μm, the pressure loss drastically increases as the fiber diameter decreases compared with when the fiber diameter is greater than or equal to 8 μm. This may be because when the fiber diameter of the polyester fiber is less than 8 μm, the frame fiber becomes thin, and the clearances in the filter paper reduce.

The relationship between the fiber diameter of the polyester fiber and the pressure loss is also studied in other combination ratios (for example, the combination ratio of the refine fiber to the polyester fiber is 70:30). According to the study, the pressure loss reduces as the combination ratio of the refined fiber decreases. In addition, when the fiber diameter is less than 8 μm, the pressure loss drastically increases as the fiber diameter decreases compared with when the fiber diameter is greater than or equal to 8 μm. Therefore, the fiber diameter is set to be greater than or equal to 8 μm. Thereby, when the combination ratio is within a range from 70 weight % to 85 weight %, the pressure loss can be restricted and can be stabilized at a low value, and the filter life can be improved.

Although the present invention has been fully described in connection with the exemplary embodiments thereof with reference to the accompanying drawings, it is to be noted that various changes and modifications will become apparent to those skilled in the art.

In the above-described embodiment, the light oil is used as fuel as an example. However, fuel is not limited to the light oil and may also be other liquid fuel. For example, the fuel may also be gasoline, alcohol fuel such as methanol, or mixed solution of gasoline and methanol.

In the above-described embodiment, the polyester fiber made of PET is used as the unrefined organic fiber as an example. However, the unrefined organic fiber may also be polyester fiber made of material other than PET (for example, polybutylene terephthalate) or other organic fiber other than polyester (for example, nylon or pulp). The cross sectional shape of the unrefined organic fibers is not limited to a circular shape. For example, the cross sectional shape of the unrefined organic fiber may be a rectangular shape or a polygonal shape. According to the study by the inventor, when the polyester fiber is made of a wood pulp having a flattened cross section of 10 μm×50 μm, the freeness of the refined fiber is 180 ml, and the combination ratio of the refined fiber to the polyester fiber is 80:20, the pressure loss is 0.4 kPa. On the other hand, when the polyester fiber has a circular cross section and other conditions are the same, the pressure loss is 0.25 kPa. Thus, the cross sectional shape of the unrefined organic fiber may also influence the pressure loss and the filter life.

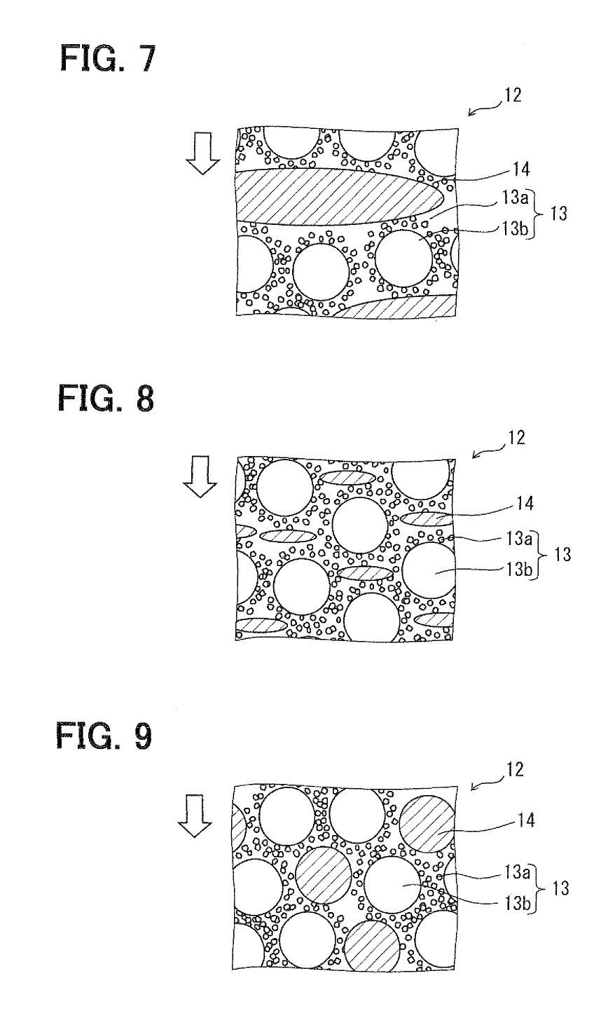

The reason will be described with reference to FIG. 7 to FIG. 9. FIG. 7 to FIG. 9 show cross sectional views of fine layers 12 made of the refined fiber 13 and the unrefined organic fiber 14. The unrefined organic fiber 14 is illustrated with hutching so that the unrefined organic fiber 14 can be distinguished from the refined fiber 13. The refined fiber 13 includes a fuzzy portion 13a and a body portion 13b that functions as the frame fiber. In FIG. 7 to FIG. 9, it is illustrated that the fuzzy portion 13a is separated from the body portion 13b. However, actually, the fuzzy portion 13a fuzzes on a surface of the body portion 13b. FIG. 7 and FIG. 8 are comparative examples, and the FIG. 9 is an exemplary embodiment of the present invention. Arrows in FIG. 7 to FIG. 9 show a flow direction of the fuel.

In a first comparative example shown in FIG. 7, the unrefined organic fiber 14 is flat in cross section. Along cross section of the unrefined organic fiber 14, the unrefined organic fiber 14 has a first dimension in a first direction and a second dimension in a second direction perpendicular to the first direction, the first dimension is within a range from 8 μm to 13 μm, and the second dimension is larger than 13 μm (for example, 10 μm×50 pin). In the fine layer 12 according to the first comparative example, the flow of the fuel may be restricted by the unrefined organic fiber 14, and the pressure loss may increase.

In a second comparative example shown in FIG. 8, the unrefined organic fiber 14 is flat in cross section. Along cross section of the unrefined organic fiber 14, the unrefined organic fiber 14 has a first dimension in a first direction and a second dimension in a second direction perpendicular to the first direction, the first outside diameter is less than 8 μm, and the second diameter is within a range from 8 μm to 13 μm (for example, 2 μm×8 μm). In the fine layer 12 according to the second comparative example, the clearances provided by the frame fiber, that is, the body portion 13b of the refined fiber 13 and the unrefined organic fiber become small, and a ratio of the fuzzy portion 13a arranged in the clearances increases. As a result, a pore size of the filter paper may become too small and the pressure loss may increase.

In the exemplary embodiment shown in FIG. 9, the unrefined organic fiber 14 is circular in cross section. Along cross section of the unrefined organic fiber 14, the unrefined organic fiber 14 has a first dimension, that is, a first diameter, in a first direction and a second dimension, that is, a second diameter, in a second direction perpendicular to the first direction, both of the first dimension and the second dimension are within a range from 8 μm to 13 μm. Furthermore, the first dimension is equal to the second dimension. In the present case, the unrefined organic fiber 14 does not excessively restrict the flow of fuel, and the pore side is not too small. Furthermore, because clearances having a predetermined size uniformly disappear, the pressure loss can be restricted.

In the above-described comparative examples, in the first direction and the second direction that are perpendicular to each other, a dimension in one direction is within the range from 8 μm to 13 μm and a dimension in the other direction is without the range from 8 μm to 13 μm. Also when the first dimension and the second dimension are within the range from 8 μm to 13 μm and a difference between the first dimension and the second dimension is large, the pressure loss may increase because of the above-described reasons. Thus; along cross section of the unrefined organic fiber 14, when the first dimension in the first direction is equal to the second dimension in the second direction perpendicular to the first direction, the pressure loss of the fine layer 12 can be effectively restricted and the filter life can be effectively improved. For example, when the unrefined organic fiber 14 is circular in cross section as shown in FIG. 9, the pressure loss of the fine layer 12 can be effectively restricted and the filter life can be effectively improved.

What is claimed is:

1. A fuel filter element comprising:
a first layer having a first pore size; and
a second layer stacked on the first layer, the second layer having a second pore size smaller than the first pore size, the second layer being a filter paper made of a fiber including a refined fiber and an unrefined organic fiber, the refined fiber being a cellulose fiber treated with a refining process and fibrillated so as to have a freeness within a range from 120 ml to 180 ml, the unrefined organic fiber having a fiber diameter within a range from 8 μm to 13 μm, the unrefined organic fiber being not treated with a refining process, the refined fiber accounting for a predetermined ratio of the fiber, the unrefined organic fiber accounting for the remain, the predetermined ratio being within a range from 70 weight % to 85 weight %.

2. The fuel filter element according to claim 1, wherein
the first layer is disposed on an upstream side in a flow direction of a fuel, and
the second layer is disposed on a downstream side in the flow direction.

3. The fuel filter element according to claim 1, wherein
along cross section of the unrefined organic fiber, the unrefined organic fiber has a first dimension in a first direction and a second dimension in a second direction perpendicular to the first direction, and
the first dimension is equal to the second dimension.

4. The fuel filter element according to claim 3, wherein
the unrefined organic fiber is circular in cross section.

5. The fuel filter element according to claim 1, wherein
the refined fiber has a body portion and a fuzzy portion on a surface of the body portion, and
the body portion has a diameter within a range from 10 μm to 11 μm.

6. The fuel filter element according to claim 1, wherein
the first layer is a filter paper made of an organic fiber, and
the first layer and the second layer are integrated by an impregnated resin.
